(19) United States
(12) Patent Application Publication
(10) Pub. No.: US 2009/0082009 A1
(43) Pub. Date: Mar. 26, 2009

(54) MOBILE COMMUNICATION DEVICE FOR MEASURING, ANALYZING, AND COMPARING WIRELESS SERVICE PROVIDER QOS

(75) Inventors: Michael E. Nagy, Tampa, FL (US); Thomas A. Butts, Tampa, FL (US)

Correspondence Address: SHUTTS & BOWEN, LLP, 100 S. ASHLEY DRIVE, SUITE 1500, TAMPA, FL, 33602, US

(73) Assignee: ACCELERATED CONCEPTS, LLC, Tampa, FL (US)

(21) Appl. No.: 12/239,606

(22) Filed: Sep. 26, 2008

Related U.S. Application Data
(60) Provisional application No. 60/995,309, filed on Sep. 26, 2007.

(51) Int. Cl. H04W 24/00; H04M 3/00

(52) U.S. Cl. 455/423; 455/456.5; 455/419; 455/67.13

(57) ABSTRACT

A portable wireless site qualifier device and associated computer systems, software, and methods are disclosed. The portable device comprises a self updating and self configuring portable measuring device that analyzes, tests, and measures quality of service on all available wireless networks and immediately displays an optimal choice(s) when choosing between multiple wireless data providers. All data is also sent to a central configuration, collection, and reporting facility.

### CROSS-REFERENCE TO RELATED APPLICATION

This application relates to the same subject matter as co-pending provisional patent application Ser. No. 60/995,309, filed by the same applicant on Sep. 26, 2007. This application claims the Sep. 26, 2007 filing date as to the common subject matter.

### BACKGROUND OF THE INVENTION

1. Field of the Invention

The disclosure relates generally to wireless communications. More particularly, the present invention relates to measuring, analyzing and comparing wireless service provider quality of service.

2. Description of the Related Art

Today a dizzying array of wireless networking choices exists and no foreseeable technology in the near future will collapse this matrix. The future additions of new frequencies (700 MHz) and new technologies such as WiMax will enhance the frustrations associated with this problem. Additionally, most users of wireless networks have no idea how or why a wireless technology works and/or which is better suited to their needs. Due to the invisibility and complexity of wireless networking, no good and affordable way exists today to determine the optimal carrier and/or even the user's choices. Today's user must play technology and provider roulette often leading to expensive, lengthy, and frustrating process. A simple to use, self configuring, and affordable portable site qualification device is needed.

### BRIEF SUMMARY OF THE INVENTION

A portable wireless site qualifier device and associated computer systems, software, and methods are disclosed. The portable device comprises a self updating and self configuring portable measuring device that analyzes, tests, and measures quality of service on all available wireless networks and immediately displays an optimal choice(s) when choosing between multiple wireless data providers. All data is also sent to a central configuration, collection, and reporting facility. A central engine may provide proper device configurations such as code levels/updates and is used to select and coordinate testing for specific devices and specific sites.

The device can display all test results locally. The device can also collect and send all testing results to a central engine, which may operate as a reporting facility. The engine can send all test results in an email and/or display via a text or graphical display to the end users. The data may also be warehoused within the device for further analysis and reporting. The engine may use authorization and authentication to protect data. Reporting and configuration applications used with the central engine are also capable of being customer branded and translated to other languages.

The device may have an open modular design that allows the insertion of different wireless technologies e.g. CDMA, UMTS, HSPDA, GSM, 802.16, 802.11, et al. The device may recognize and report on as many networks as possible with as few as possible network interfaces.

The device and the device specific website allow the input of specific geographic data to allow a specific field test to be correlated with the request. A unique serial number and customer account may be provided in the system of the invention to create a device specific website. Customer with multiple devices may be able to select several devices from a common page. In order to track tests to a specific instance and to allow custom tests at every location, the device may retrieve test and communication information using a repository in electronic communication with the central engine. The tester will be able to enter a correlating field to allow the device to determine the test suite, the destined users, and any other test specific data. In the event that no test data is found an error may be displayed. The user may receive a prompt for the tester to allow a default test. The default test is also provided by the central engine.

The device will have the ability to perform the following tasks:

a. Boot the operating system and initialize the test application;

b. Query the central engine for current firmware level and all hardware specific configurations;

c. Update firmware if necessary and reboot if necessary;

d. Upload any archived testing data;

e. Initialize and confirm hardware;

f. Query the central engine for tests assigned to the device;

g. Prompt a user with a list of available pre-set tests and/or the ability to enter a custom test;

h. Capture tester input;

i. Run specific tests and generate results;

j. Display test results to tester on the device; and

k. Send data to a central engine, or, if a send error occurs, archive data locally.

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

### BRIEF DESCRIPTION OF THE DRAWINGS

The accompanying drawings, which are incorporated in and constitute part of this specification, illustrate an embodiment of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an embodiment of the system of the present invention.

FIG. 2 is a schematic diagram of an embodiment of the device of the present invention.

FIG. 3 is a data flow diagram for the present invention.

FIG. 4 is a data flow chart of a system embodying the invention.

FIG. 5 illustrates an input screen for configuration of a device embodying the invention.

FIG. 6 illustrates an input screen for a testing request for a device embodying the invention.

FIG. 7 illustrates testing report for a system embodying the invention.

### DETAILED DESCRIPTION OF THE INVENTION

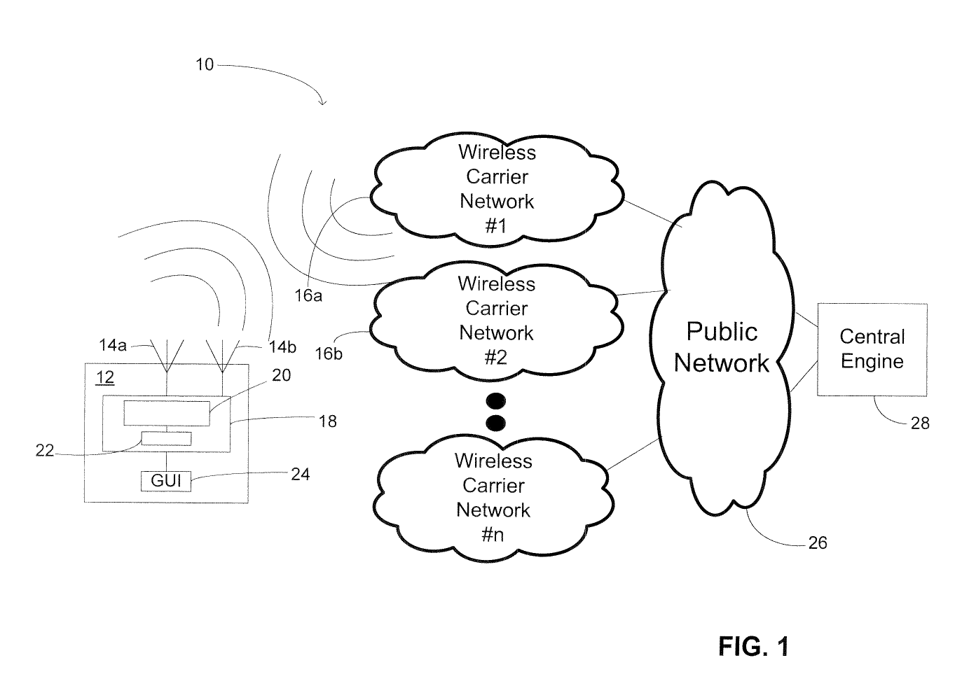

The present invention is a system for testing the quality of service of one or more wireless network transmissions, shown generally in FIG. 1 at 10. The system includes a device 12 that may be portable so that the device 12 may be brought to various locations for testing. The device 12 includes a plurality of transceivers 14a and 14b, each of which is capable of transmitting to and receiving from a different type of wireless network transmission 16a and 16b. Various types of networks may be used with the device, including radio, CDMA, UMTS, HSPDA, GSM, 802.1x and 802.16 technologies. The device further includes a CPU 18 including a testing application for quality of service or tester 20 for each type of wireless network transmission. The tester 20 is in electronic communication with the transceivers 14a and 14b. The device also includes a quality of service report generator application 22 or report generator in electronic communication with the tester 20. The device further includes a GUI 24 in electronic communication with the CPU 18. Thus the GUI 24 is in electronic communication with the tester of quality of service 20 and the quality of service report generator 22.

Information from the device 12 is carried from the device 12 via a wireless network transmission through a public network 26 to a remote central engine 28. The central engine 28 may be a computer such as a network server or the equivalent. The central engine 28 serves the device 12 by transmitting data and instructions to the device 12 and performing other functions as described below.

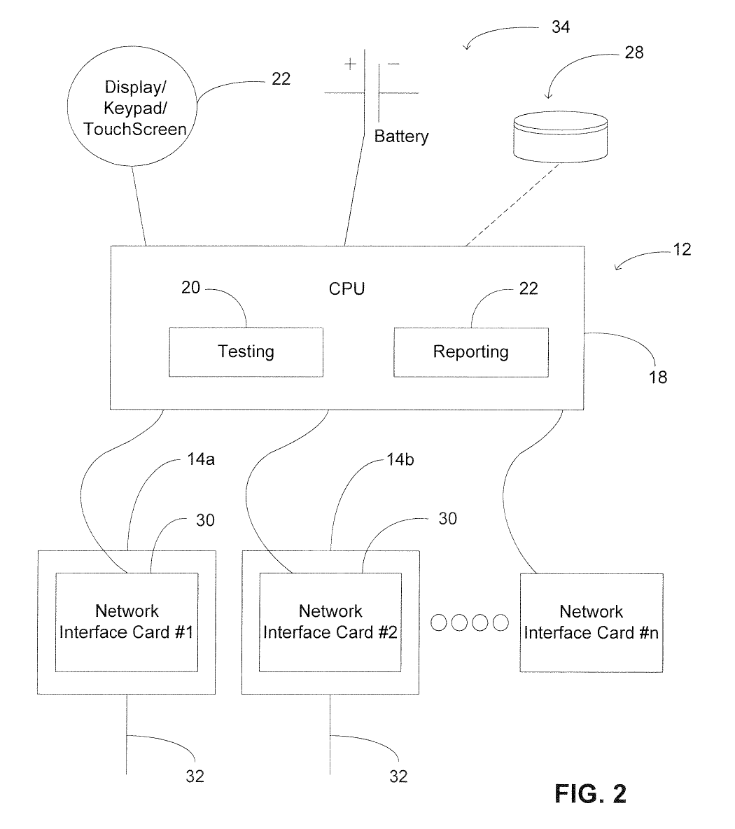

FIG. 2 is a more detailed schematic diagram of an embodiment of the device 12. As shown the device 12 includes a CPU 18. The CPU 18 includes applications including one or more testers 20 and quality of service report generator 22. The CPU 18 is in electronic communication with a plurality of transceivers 14a and 14b. As shown, a transceiver 14a may comprise a network card 30 in electronic communication with a wireless modem 32. Examples of transceivers that may be used in the subject invention include Sierra Wireless Models 881u, 595u, Compass 597 and Compass 885. However, other network interface cards or “aircards” are also contemplated.

The device 12 includes a power source 34 that may be attached to the device 12, such as a battery. Also, the GUI 22 associated with the device 12 may include a display with a keypad, a touch-screen or other user interface known in the art.

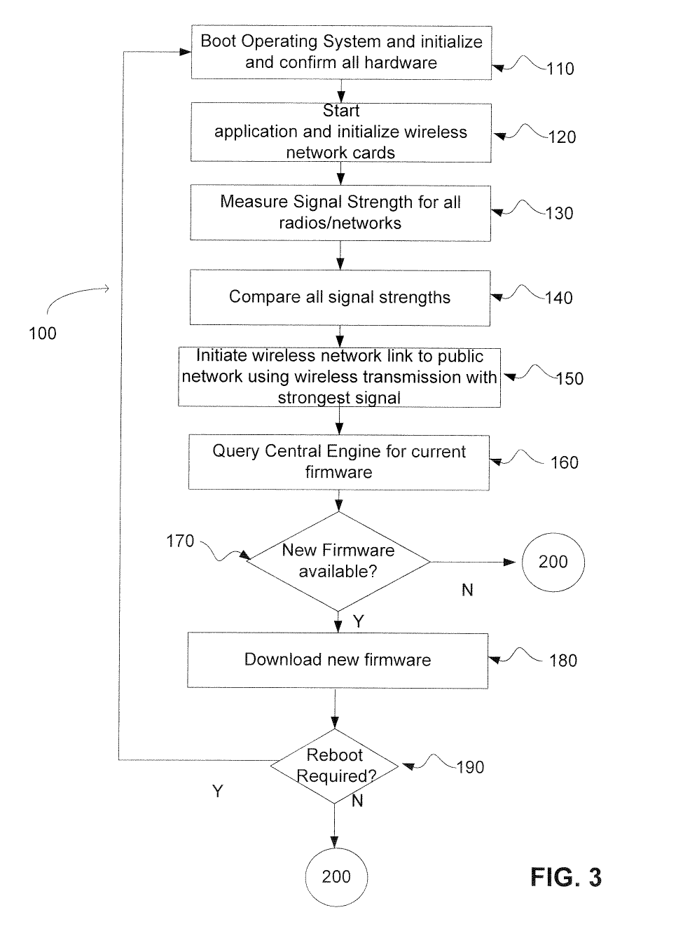

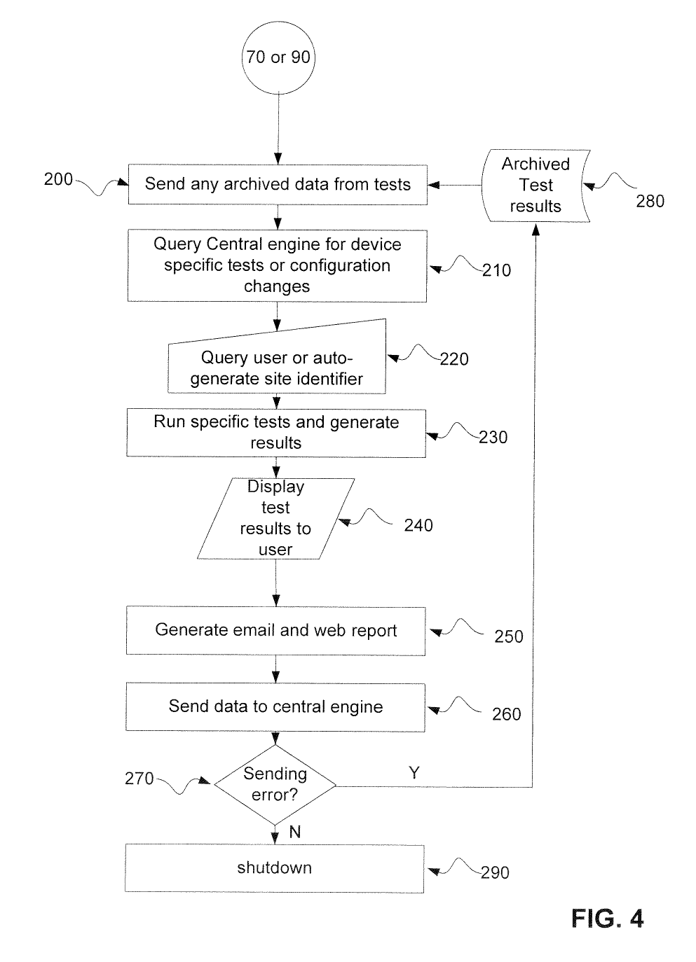

In illustration of the operation of the subject invention, FIGS. 3 and 4 show a flow chart illustrating a data flow for an embodiment of the device. Beginning at the starting block 110, the operating system of the device is booted and hardware such as the GUI can be initialized and confirmed.

Then in block 120 the testing and reporting applications can be started and transceivers such as the network cards can be initialized.

In block 130, signal strength for all wireless network transmissions can be received by the device.

In block 140, the received signal strengths are compared be the device.

In block 150, the device can initiate a wireless network link to the public network using the wireless network transmission with the strongest signal

In block 160, the device can query the central engine for updates to the firmware associated with the device. If updates are available the updates can be downloaded into the device at block 180.

In block 190, the central engine can communicate to the device that a reboot is required to initialize downloaded firmware, and the central engine will automatically reboot the device. The device may alternatively be rebooted manually.

After the firmware has been initialized, in block 200, the device can transmit to the central engine archived data from prior tests, if the archived data exists.

In block 210, the device can query the central engine for specific tests to be performed by the device. The central engine can then respond to the query and provide data as required. For example, specifically named files, or a series of specific files, may be uploaded and/or downloaded to the device for the test. Also, the device may receive configuration changes for the transceivers from the central engine.

In block 220, a website specific for the device is identified. The website is in electronic communication with the central engine. The website may be used for the reporting of test results, identification of files to be used for testing, and the identification of changes in the configuration of the transceivers of the device.

In block 230, the device can run a requested and identified test on a wireless network transmission.

A report on the results of the test is then generated. In block 240, the results of the test can be displayed on the GUI of the device.

In block 250, an email, a web report data file, or both can be created by the device. In block 260, the email, the web report data file, or both, can be sent to the central engine via the wireless network identified and used in block 150.

The device then can query whether a sending error is detected by the device in block 270. If an error has been detected then in block 280 the test results can be archived. Once archived, a second attempt at sending the test results can be performed.

In an embodiment of the invention, the system includes the ability to determine the location of the device electronically. This ability may be achieved through a means for determining the location of the device, such as a GPS antenna. Alternatively, the location may be determined by utilizing the operation of the transceiver such as 14a or 14b through cell tower triangulation, or equivalent means for determining the location of the device known in the art.

In another embodiment of the invention, the system 10 may include a website specific to the device 12 in electronic communication with the device 12. The website may in turn be in electronic communication with the central engine 28. The website may also be capable of allowing input of requests for alteration to testing protocols for the system 10. The website may also allow the input of specific geographic data related to the location of the device, so that the testing of the networks has the local geography as a defined variable for the test.

In yet another embodiment of the invention, the quality of service report generator 22 is in electronic communication with an email generator on the device 12. Thus the results of the test may be transmitted directly from the device. Alternatively, the quality of service report generator 22 may be in electronic communication with the central engine 28, and the central engine may generate an email containing the test results.

In still another embodiment of the invention, a user of the tester of quality of service 20 is capable of testing uploads and downloads of data files from a wireless network transmission to the device. The data files to be used during testing may be specified in the central engine. Further, the data files to be used in a test may be specified in the website specific to the device 12.

Among the tests which may be performed by the device are low-level connectivity and latency, upload and download bandwidths, and mixed packet transfer liability, latency and throughput of the wireless network transmission. However, other tests known in the art are also contemplated for this invention.

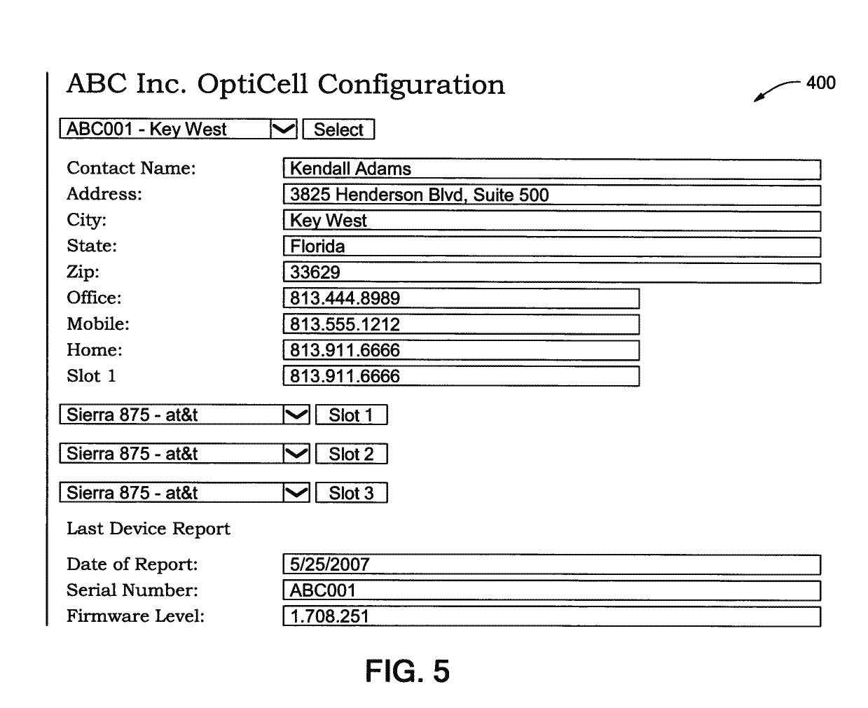

FIG. 5 illustrates an input screen for configuration of a device embodying the invention at 400. As shown, a user of the system 10 may select various configuration for the transceivers of the device. Further, the user may obtain information regarding the last test at a particular location and the last update of the firmware of the device at the time of the last test.

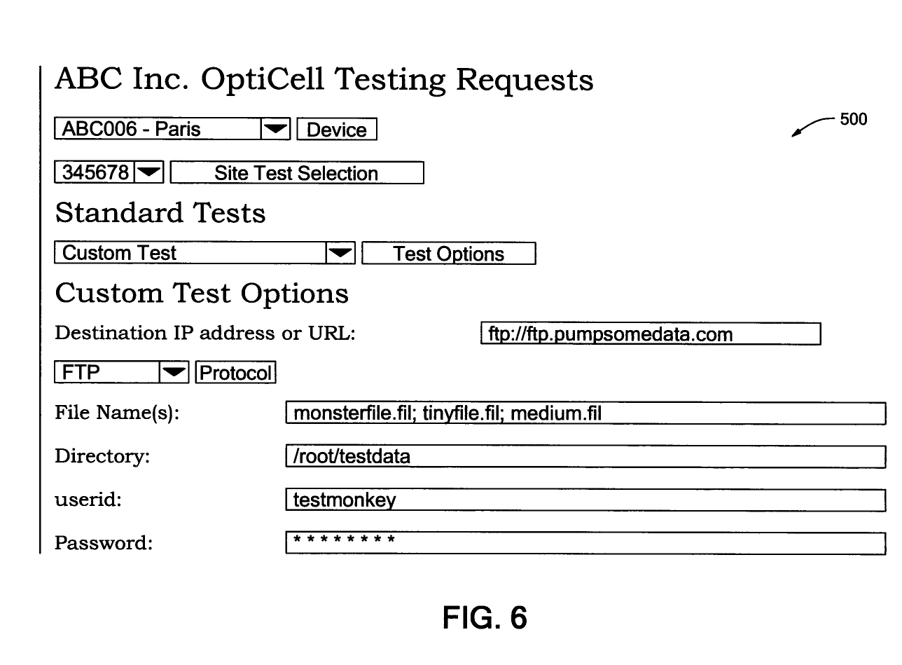

FIG. 6 illustrates an input screen for a testing request for a device embodying the invention at 500. As shown, standard pre-set testing files or custom testing files may be used by the system to perform its testing functions. Furthermore, a user may identify an individual transceiver to be tested.

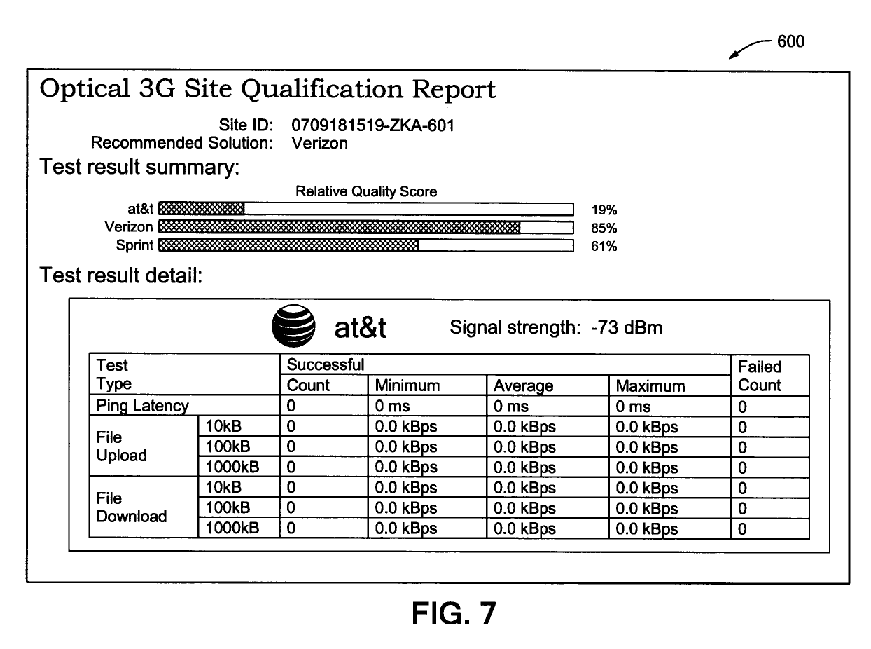

FIG. 7 illustrates a summary testing report for a system embodying the invention at 600. As shown, the system can provide a comparison of several wireless network transmissions. Also, a unique site ID may be provided for the test. Details of each network tested may also be provided to the user of the system.

In another embodiment of the invention, the device 12 and the device specific website allow the input of specific geographic data to allow a specific field test to be correlated with the request. Each time a user purchases a device the serial number and customer account may be used to create a device specific website. Customer with multiple devices may be able to select devices from a common page. In order to track tests to a specific instance and to allow custom tests at every location, the device may have the ability to retrieve specific test and communication information using a central repository in electronic communication with the central engine. A user of the system may enter in the configuration screen 400 and the test selection screen 500 information to allow the device to determine a test suite, the destined users, and any other test specific data. In the event that no test data is found an error may be displayed and a prompt for the user to allow a default test. The default test is also provided by the central configuration engine.

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

Embodiments of the invention can take the form of an entirely hardware embodiment, an entirely software embodiment or an embodiment containing both hardware and software elements. In a preferred embodiment, the invention is implemented in hardware and software, which includes but is not limited to firmware, resident software, microcode, and the like. Furthermore, the invention can take the form of a computer program product accessible from a computer-usable or computer-readable medium providing program code for use by or in connection with a computer or any instruction execution system.

What is claimed is:

1. A quality of service measuring system, comprising:
a measuring device, including
a plurality of transceivers, each of which is capable of receiving a different type of wireless network transmission; and
a tester of quality of service for each type of wireless network transmission in electronic communication with the transceivers;
a quality of service report generator; and
a GUI in electronic communication with the tester and the quality of service report generator.

2. The system of claim 1, further comprising a website specific to the device in electronic communication with the device.

3. The system of claim 2, wherein the website is capable of allowing an input of requests for alteration to testing protocols for the system.

4. The system of claim 2, wherein the website is capable of allowing an input of specific geographic data related to the location of the device.

5. The system of claim 1, wherein the quality of service report generator is in electronic communication with an email generator.

6. The system of claim 1, wherein the tester of quality of service is capable of testing downloads of data files from the wireless network transmission to the device.

7. The system of claim 6, wherein the tester of quality of service is capable of testing uploads of data files from the device via the wireless network transmission.

8. The system of claim 1, further comprising a central engine in electronic communication with the device.

9. The system of claim 8, wherein the central engine is capable of transmitting to the device firmware updates and configuration data for the transceivers.

10. The system of claim 9, wherein the central engine is capable of rebooting the device.

11. The system of claim 9, wherein the central engine is capable of receiving archived test data from the device.

12. The system of claim 1, wherein the measuring device includes a means for determining the location of the measuring device.

13. The system of claim 12, wherein the means for determining location includes a GPS antenna.

14. The system of claim 12, wherein the means for determining location includes the use of cell tower triangulation.

15. The system of claim 1, wherein the tester of quality of service is capable of testing low-level connectivity and latency, upload and download bandwidths, and mixed packet transfer liability, latency and throughput of the wireless network transmission.

16. A quality of service measuring device, including:
a plurality of transceivers, each of which is capable of receiving a different type of wireless network transmission;
a tester of quality of service for each type of wireless network transmission in electronic communication with the transceivers;
a quality of service report generator; and
a GUI in electronic communication with the tester and the quality of service report generator.

17. The device of claim 16, wherein the GUI is capable of displaying data from the quality of service report generator.

18. The device of claim 17, wherein the tester of quality of service is capable of testing low-level connectivity and latency, upload and download bandwidths, and mixed packet transfer liability, latency and throughput of the wireless network transmission.

19. The device of claim 16, further comprising an electronic connection to a website specific to the device.

20. The device of claim 19, wherein the website is capable of allowing an input of requests for alteration to testing protocols for the device.

21. The device of claim 16, wherein the website is capable of allowing an input of specific geographic data related to the location of the device.

22. The device of claim 16, further comprising a means for determining the location of the device.

23. A method for testing a wireless network transmission using the invention described herein.
